(19) United States
(12) Patent Application Publication
(10) Pub. No.: US 2005/0165978 A1
(43) Pub. Date: Jul. 28, 2005

(54) Apparatus and method of managing device jobs using hosts

(76) Inventor: Hyoung-tae Kim, Suwon-si (KR)

Correspondence Address: STANZIONE & KIM, LLP, 1740 N STREET, N.W., FIRST FLOOR, WASHINGTON, DC, 20036, US

(21) Appl. No.: 11/032,170

(22) Filed: Jan. 11, 2005

(30) Foreign Application Priority Data
Jan. 24, 2004 (KR) 2004-4571

(51) Int. Cl. G06F 3/00

(52) U.S. Cl. 710/15

(57) ABSTRACT

A method and apparatus to manage device jobs using hosts. The method includes checking job instruction items issued to devices by the hosts, detecting job priority information regarding hosts instructed for a particular device among the devices to perform a job from the job instruction items, and transmitting job data for device jobs to the particular device according to the job priority information. Since the hosts rather than the devices manage jobs of the devices whose operations are controlled through a network, a network card in each device can perform device jobs without a central processing unit (CPU).

### CROSS-REFERENCE TO RELATED APPLICATIONS

This application claims the priority of Korean Patent Application No. 10-2004-0004571, filed on Jan. 24, 2004, in the Korean Intellectual Property Office, the disclosure of which is incorporated herein in its entirety by reference.

### BACKGROUND OF THE INVENTION

1. Field of the Invention

The present general inventive concept relates to technology of performing device jobs in a network through which a host is connected to a device such as a printer or a scanner, and more particularly, to an apparatus and method of allowing a host to manage processing priorities for device jobs when a particular device is almost simultaneously requested to perform a plurality of device jobs.

2. Description of the Related Art

Conventionally, when device jobs are performed through a network connecting hosts and devices, a network card provided in each device usually manages device jobs. To manage device jobs, a job scheduler is required. The job scheduler is a program that prepares for a new job after finishing a current job in order to continuously perform jobs, and is referred to as a job management program. The job scheduler selects one job among all of requested jobs and allocates resources necessary for the selected job. In other words, the job scheduler selects a process stored in an auxiliary memory device and loads the process onto a main memory device. Accordingly, a central processing unit (CPU) in a network card starts a job scheduler so that device jobs are sequentially performed according to the order in which the device jobs are requested. For example, where hosts and printers are connected through a network, if a plurality of hosts almost simultaneously send printing commands to a particular printer, a network card in the particular printer manages jobs such that printing is performed according to the order in which the printing commands are received.

However, since a network card provided in a device (e.g., a printer, a scanner, or a multi-function peripheral) needs to include a CPU operating a job scheduler for job management, manufacturing costs for the network card are increased.

### SUMMARY OF THE INVENTION

The present general inventive concept provides a method of managing processing priorities for device jobs using hosts.

The present invention also provides an apparatus to manage processing priorities for device jobs using hosts.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a method of managing processing priorities for device jobs using hosts, the method comprising: checking job instruction items issued to the devices by the hosts; detecting job priority information regarding hosts instructed for a particular device among the devices to perform a job from the job instruction items; and transmitting job data for device jobs to the particular device according to the job priority information.

The foregoing and/or other aspects and advantages of the present general inventive concept may also be achieved by providing an apparatus to manage processing priorities for device jobs using hosts, the apparatus comprising: a job instruction items checker checking job instruction items issued to the devices by the hosts; a job priority information detector detecting job priority information regarding hosts instructed for a particular device among the devices to perform a job from the job instruction items; and a data transmitter transmitting job data for device jobs to the particular device according to the job priority information.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a flowchart of a method of managing device jobs using hosts according to an embodiment of the present general inventive concept; and

FIG. 2 is a block diagram of an apparatus to manage device jobs using hosts according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

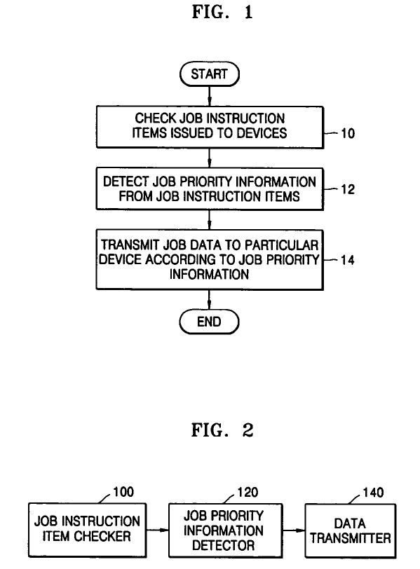

Referring to FIG. 1, a method of managing device jobs using hosts according to an embodiment of the present general inventive concept includes transmitting job data to a particular device according to job priority information detected from job instruction items in operations 10 through 14.

In detail, the job instruction items issued to devices by hosts are checked in operation 10. The job instruction items issued to the devices are stored in spoolers of the hosts. A spooler is a program that reads a document or a job list of a host and stores it in a hard disk or a large capacity storage medium so that device jobs can be processed at a convenient time. Accordingly, the job instruction items can be checked by checking the spoolers of the hosts. Each job instruction item stored in a spooler of a host includes content of a job command issued to a device and a time when the job instruction item is stored in the host's spooler.

After operation 10, the job priority information regarding hosts instructing a particular device among the devices to do a job is detected from the job instruction items in operation 12. The job priority information defines priorities for job performance given to the hosts according to which job issued by a certain host is performed prior to jobs issued by other hosts. The priorities for job performance given to the hosts are determined according to times when the job instruction items are stored in the hosts' spoolers. Each job instruction item includes information regarding a time when the job instruction item is stored in a host's spooler. Accordingly, the job priority information can be detected from the job instruction items. A job instruction item stored in a spooler earlier is performed by a device prior to a job instruction item stored in a spooler later.

After operation 12, job data for device jobs are transmitted to the particular device according to the job priority information, in operation 14. If other hosts have priority for job performance over a current host according to the job priority information, after the other hosts transmit job data to the particular device, the current host transmits job data to the particular device. In operation 14, device jobs corresponding to the job data transmitted to the particular device are performed according to ranking in which the job data are received by the particular device.

Operations 10 through 14 of FIG. 1 are performed by each host. In other words, each host manages device jobs that a device is commanded to perform by the host through a network. Accordingly, the device can normally perform device jobs without a central processing unit (CPU) in a network card.

For clarity of the description, an assumption is made that the particular device is a printer and a device job is a printing job. Each of the hosts checks job instruction items issued by all of the hosts to devices including the printer. As described above, the job instruction items can be checked by checking spoolers of the respective hosts.

Thereafter, job priority information regarding the hosts instructed for the printer among the devices to do the printing job is detected from the job instruction items. The job priority information defines priorities for a printing job given to the hosts according to which printing job issued by a certain host is performed prior to printing jobs issued by other hosts.

Thereafter, job data for printing jobs is transmitted to the printer according to the job priority information. If other hosts have priority for job performance over a current host according to the job priority information, after the other hosts transmit job data to the printer, the current host transmits job data to the printer. The printing jobs corresponding to the job data transmitted to the printer are performed according to the order in which the job data are received by the printer.

Hereinafter, an apparatus to manage device jobs using hosts, according to an embodiment of the present general inventive concept will be described with reference to the attached drawings. Referring to FIG. 2, the apparatus to manage device jobs using hosts includes a job instruction item checker 100, a job priority information detector 120, and a data transmitter 140.

The job instruction item checker 100 checks job instruction items issued to devices by hosts connected to a network by checking spoolers (not shown) of the hosts. A spooler of each host stores a job instruction item including content of a job command issued to a device and/or a time when a job command is stored in the spooler. The job instruction item checker 100 transmits a result of checking the job instruction items to the job priority information detector 120.

The job priority information detector 120 detects job priority information regarding hosts instructed for a particular device to perform a job from the job instruction items. The job priority information detector 120 detects the job priority information based on times when the respective job instruction items are stored in the spoolers. The job priority information detector 120 receives the job instruction items from the job instruction item checker 100, detects the job priority information from the job instruction items, and transmits the job priority information to the data transmitter 140.

The data transmitter 140 transmits job data for device jobs to the particular device according to the job priority information. More specifically, the data transmitter 140 receives the job priority information from the job priority information detector 120 and transmits the job data for the device jobs according to the order defined by the job priority information.

The device jobs corresponding to the job data transmitted to the particular device are performed by the particular device in the order in which the particular device receives the job data.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A method of managing device jobs using hosts connected to devices through a network, the method comprising:
checking job instruction items issued to the devices by the hosts;
detecting job priority information regarding hosts instructed for a particular device among the devices to perform a job from the job instruction items; and
transmitting job data for device jobs to the particular device according to the job priority information.

2. The method of claim 1, wherein the checking of the job instruction items comprises checking spoolers of the respective hosts.

3. The method of claim 2, wherein the detecting of the job priority information comprises detecting the job priority information based on times when the respective job instruction items are stored in the spoolers.

4. The method of claim 3, further comprising:
performing the device jobs corresponding to the job data according to ranking in which the particular device receives the job data.

5. The method of claim 1, wherein the particular device is a printer and the device jobs are printing jobs.

6. An apparatus to manage device jobs using hosts connected to devices through a network, the apparatus comprising:
a job instruction items checker checking job instruction items issued to the devices by the hosts;
a job priority information detector detecting job priority information regarding hosts instructed for a particular device among the devices to perform a job from the job instruction items; and
a data transmitter transmitting job data for device jobs to the particular device according to the job priority information.

7. The apparatus of claim 6, wherein the job instruction items checker checks the job instruction items by checking spoolers of the respective hosts.

8. The apparatus of claim 7, wherein the job priority information detector detects the job priority information based on times when the respective job instruction items are stored in the spoolers.

9. A method of managing device jobs using hosts connected to plural devices through a network, the method comprising:
determining priority information of the device jobs stored in the hosts which the devices are commanded to perform; and
transmitting job data for the device jobs to a particular device according to the determined priority information.

10. The method of claim 9, wherein the priority information includes a priority level at which a particular device is instructed by the host to perform a device job, and is determined from job instruction items issued to the devices and stored in spoolers of the respective hosts.

11. The method of claim 10, wherein the job instruction items comprise content of a job command issued to a device and a time when the job instruction item is stored in the host's spooler.

12. The method of claim 10, wherein the devices are printers, and the priority information defines priorities for printing a job given to the hosts according to which printing job issued by a certain host is performed prior to printing jobs issued by other hosts.

13. A computer readable storage medium containing a method of managing device jobs using hosts connected to devices through a network, the method performing the operations of:
checking job instruction items issued to the devices by the hosts;
determining job priority information regarding hosts instructed for a particular device among the devices to perform a job from the job instruction items; and
transmitting job data for device jobs to the particular device according to the job priority information.

14. The computer readable storage medium of claim 13, wherein the checking of the job instruction items comprises checking spoolers of the respective hosts.

15. The computer readable storage medium of claim 14, wherein the detecting of the job priority information comprises detecting the job priority information based on times when the respective job instruction items are stored in the spoolers.

16. The computer readable storage medium of claim 15, wherein the method further comprises the operation of performing the device jobs corresponding to the job data according to ranking in which the particular device receives the job data.

17. The computer readable storage medium of claim 13, wherein the particular device is a printer and the device jobs are printing jobs.
